(19) United States
(12) Patent Application Publication
(10) Pub. No.: US 2007/0152580 A1
(43) Pub. Date: Jul. 5, 2007

(54) Plasma display panel (PDP)

(76) Inventors: Hyun Kim, Suwon-si (KR); Kyoung-Doo Kang, Suwon-si (KR); Se-Jong Kim, Suwon-si (KR); Hyun Soh, Suwon-si (KR); Yun-Hee Kim, Suwon-si (KR); Jin-Won Han, Suwon-si (KR)

Correspondence Address: Robert E. Bushnell, Suite 300, 1522 K Street, N.W., Washington, DC, 20005, US

(21) Appl. No.: 11/511,437

(22) Filed: Aug. 29, 2006

(30) Foreign Application Priority Data
Dec. 31, 2005 (KR) 10-2005-0136231

(51) Int. Cl. H01J 17/49

(52) U.S. Cl. 313/582

(57) ABSTRACT

Provided is a Plasma Display Panel (PDP) that reduces a discharge voltage. The PDP includes: a substrate; at least one pair of sustain electrodes arranged on the substrate; and a dielectric layer covering the sustain electrodes; a virtual extension line of discharge gaps between the at least one pair of sustain electrodes crosses a direction in which the at least one pair of sustain electrodes extend, and grooves corresponding to the discharge gaps are arranged on the dielectric layer.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on the 31^{st} of Dec. 2005 and there duly assigned Serial No. 10-2005-0136231.

### BACKGROUND OF THE INVENTION

1. Field of the Invention

The present invention relates to a Plasma Display Panel (PDP), and more particularly, to a PDP that reduces a discharge voltage.

2. Description of the Related Art

Plasma Display Panels (PDP) which have replaced conventional cathode ray tube (CRT) display devices display desired images using visible light generated by sealing discharge gas and applying discharge voltage between two substrates on which a plurality of electrodes are formed to generate vacuum ultraviolet rays and exciting phosphor on which the vacuum ultraviolet rays are formed in a predetermined pattern.

An Alternating Current (AC) PDP includes an upper plate that displays an image to a user and a lower plate that is combined with and parallel to the upper substrate. A plurality of pairs of discharge sustain electrodes including Y electrodes and X electrodes are disposed on a front substrate of the upper plate. Address electrodes are disposed on a rear substrate of the lower plate that opposes the front substrate and cross the Y electrodes and the X electrodes. The Y electrodes and the X electrodes respectively include transparent electrodes and bus electrodes. A Y electrode and an X electrode and an address electrode crossing the Y electrode and the X electrode form a unit discharge cell, which is a discharge unit. A front dielectric layer and a rear dielectric layer are respectively formed on the front substrate and the rear substrate to bury each of the electrodes. A protective layer formed of MgO is formed on the front dielectric layer. Barrier ribs that maintain a discharge distance and prevent electrical and optical cross-talk between discharge cells are formed on a front surface of the rear dielectric layer. Phosphor layers are coated on both sides of the barrier ribs and on a front surface of the rear dielectric layer where the barrier ribs are not formed.

The AC PDP must increase a distance G between the Y electrodes and the X electrodes in order to improve brightness and luminous efficiency, because an increased discharge area results in an active generation of a plasma discharge. However, as the distance G increases, a voltage for starting a discharge is also increased. In this regard, a rated voltage of electronic devices for driving the Y electrodes and the X electrodes increases, which causes an increase in costs.

### SUMMARY OF THE INVENTION

The present invention provides a Plasma Display Panel (PDP) that reduces a discharge voltage.

The present invention also provides a PDP having an increased aperture rate.

The present invention also provides a PDP that has increased luminous efficiency.

According to one aspect of the present invention, a PDP is provided including: a substrate; at least one pair of sustain electrodes arranged on the substrate; and a dielectric layer covering the sustain electrodes; a virtual extension line of discharge gaps between the at least one pair of sustain electrodes crosses a direction in which the at least one pair of sustain electrodes extend, and grooves corresponding to the discharge gaps are arranged on the dielectric layer.

At least some of the grooves are preferably parallel to the discharge gaps.

The at least one pair of sustain electrodes preferably include bus electrodes extending parallel to each other, and transparent electrodes respectively electrically connected to the bus electrodes; the virtual extension line of the discharge gaps is preferably parallel to opposing surfaces of pairs of transparent electrodes.

At least some of the grooves are preferably parallel to the opposing surfaces of the pairs of transparent electrodes.

The virtual extension line of the discharge gaps is preferably oblique to the direction in which the at least one pair of sustain electrodes extend. The virtual extension line of the discharge gaps preferably crosses the direction in which the at least one pair of sustain electrodes extend.

According to another aspect of the present invention, a Plasma Display Panel (PDP) is provided including: a front substrate and a rear substrate opposing each other; barrier ribs arranged between the front substrate and the rear substrate and partitioning a plurality of discharge cells; a plurality of pairs of sustain electrodes spaced apart from each other on the front substrate opposing to the rear substrate; address electrodes extending to cross the plurality of pairs of sustain electrodes; a front dielectric layer covering the plurality of pairs of sustain electrodes; a rear dielectric layer disposed to cover the address electrodes; phosphor layers arranged within the plurality of discharge cells; and a discharge gas contained within the plurality of discharge cells; a virtual extension line of discharge gaps between the pairs of sustain electrodes crosses a direction in which the pairs of sustain electrodes extend, and grooves corresponding to the discharge gaps are arranged on the front dielectric layer.

At least some of the grooves are preferably parallel to the discharge gaps.

The pairs of sustain electrodes preferably include bus electrodes extending parallel to each other, and transparent electrodes respectively electrically connected to the bus electrodes; the virtual extension line of the discharge gaps is preferably parallel to opposing surfaces of pairs of transparent electrodes.

At least some of the grooves are preferably parallel to the opposing surfaces of the pairs of transparent electrodes.

The virtual extension line of the discharge gaps is preferably oblique to the direction in which the pairs of sustain electrodes extend. The virtual extension line of the discharge gaps preferably crosses the direction in which the pairs of sustain electrodes extend.

The front substrate is preferably exposed through the grooves. The grooves are preferably discontinuously formed in each of the plurality of discharge cells.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a cross-sectional view of an Alternating Current (AC) Plasma Display Panel (PDP);

FIG. 2 is a partially exploded perspective view of a PDP according to an embodiment of the present invention;

FIG. 3 is a partial cross-sectional view taken along a line III-III of FIG. 2, according to an embodiment of the present invention;

FIG. 4 is a layout diagram of sustain electrodes, barrier ribs, and grooves of FIG. 2, according to an embodiment of the present invention;

FIG. 5 is a partially exploded perspective view of a PDP according to another embodiment of the present invention; and

FIG. 6 is a layout diagram of sustain electrodes, barrier ribs, and grooves according to another embodiment of the present invention.

### DETAILED DESCRIPTION OF THE INVENTION

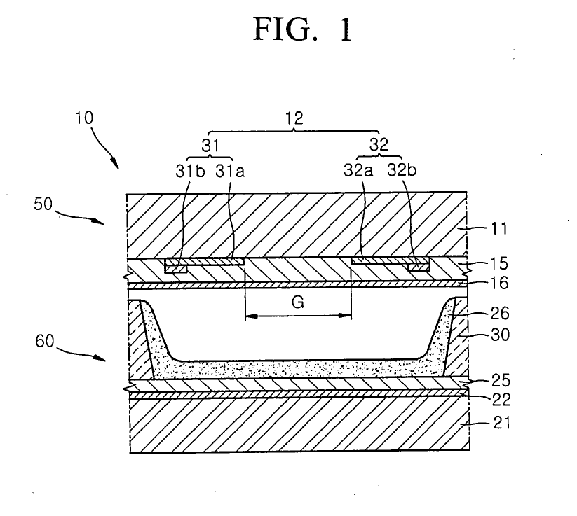

FIG. 1 is a cross-sectional view of an Alternating Current (AC) Plasma Display Panel (PDP) 10. Referring to FIG. 1, the PDP 10 includes an upper plate 50 that displays an image to a user and a lower plate 60 that is combined with and parallel to the upper substrate 50. A plurality of pairs of discharge sustain electrodes 12 including Y electrodes 31 and X electrodes 32 are disposed on a front substrate 11 of the upper plate 50. Address electrodes 22 are disposed on a rear substrate 21 of the lower plate 60 that opposes the front substrate 11 and cross the Y electrodes 31 and the X electrodes 32. The Y electrodes 31 and the X electrodes 32 respectively include transparent electrodes 31a and 32a and bus electrodes 31b and 32b. A Y electrode 31 and an X electrode 32 and an address electrode 22 crossing the Y electrode 31 and the X electrode 32 form a unit discharge cell, which is a discharge unit. A front dielectric layer 15 and a rear dielectric layer 25 are respectively formed on the front substrate 11 and the rear substrate 21 to bury each of the electrodes. A protective layer 16 formed of MgO is formed on the front dielectric layer 15. Barrier ribs 30 that maintain a discharge distance and prevent electrical and optical cross-talk between discharge cells are formed on a front surface of the rear dielectric layer 25. Phosphor layers 26 are coated on both sides of the barrier ribs 30 and on a front surface of the rear dielectric layer 25 where the barrier ribs 30 are not formed.

The AC PDP 10 must increase a distance G between the Y electrodes 31 and the X electrodes 32 in order to improve brightness and luminous efficiency, because an increased discharge area results in an active generation of a plasma discharge. However, as the distance G increases, a voltage for starting a discharge is also increased. In this regard, a rated voltage of electronic devices for driving the Y electrodes 31 and the X electrodes 32 increases, which causes an increase in costs.

Hereinafter, the present invention is described more fully with reference to the accompanying drawings, in which exemplary embodiments of the present invention are shown.

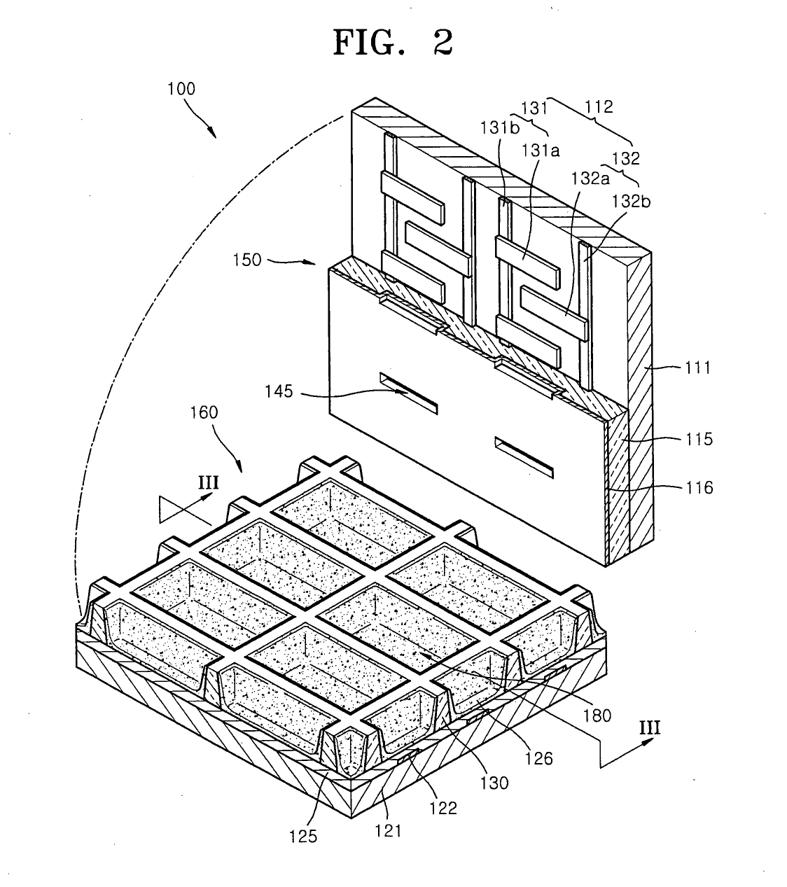

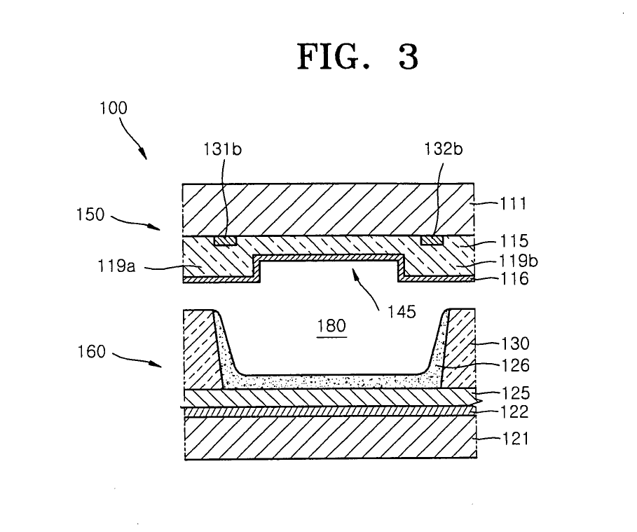

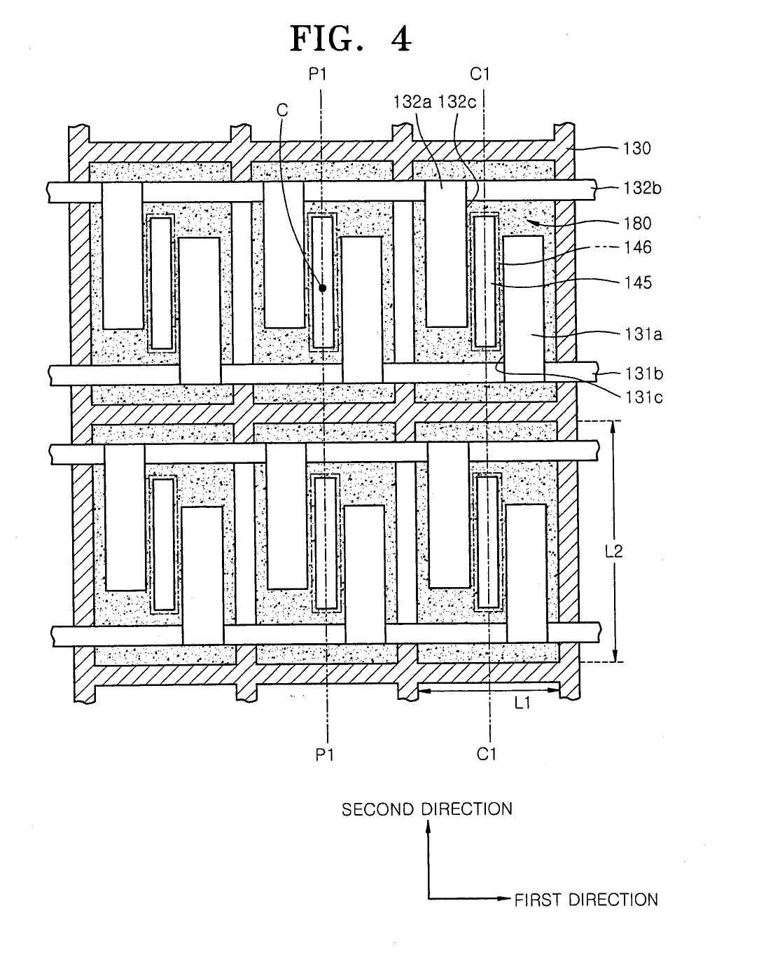

FIG. 2 is a partially exploded perspective view of a PDP 100 according to an embodiment of the present invention. FIG. 3 is a partial cross-sectional view taken along a line III-III of FIG. 2, according to an embodiment of the present invention. FIG. 4 is a layout diagram of sustain electrodes, barrier ribs, and grooves of FIG. 2, according to an embodiment of the present invention. Like reference numerals in the drawings denote like elements.

Referring to FIGS. 2 and 3, the PDP 100 includes an upper plate 150 and a lower plate 160 which is combined with and parallel to the upper plate 150. The upper plate 150 includes a front substrate 111, a front dielectric layer 115, pairs of sustain electrodes 112, and a protective layer 116. The lower plate 160 includes a rear substrate 121, address electrodes 122, a rear dielectric layer 125, barrier ribs 130, and phosphor layers 126.

The front substrate 111 and the rear substrate 121 are spaced apart from each other by a predetermined gap and define discharge spaces therebetween for generating a discharge. The front substrate 111 and the rear substrate 121 are formed of a material having excellent light transmission properties, such as glass. However, the front substrate 111 and/or the rear substrate 121 can be colored in order to increase the bright room contrast.

The barrier ribs 130 are disposed between the front substrate 111 and the rear substrate 121, more particularly, on the rear dielectric layer 125. The barrier ribs 130 partition the discharge spaces into a plurality of discharge cells 180 and prevent optical and electrical cross-talk between the discharge cells 180. Referring to FIG. 2, the barrier ribs 130 partition the discharge cells 180 having tetragonal cross-sections arranged in a matrix. However, the present invention is not limited thereto. In more detail, the discharge cells 180 can have polygonal cross-sections, such as triangular cross-sections, tetragonal cross-sections, pentagonal cross-sections, circular cross-sections, oval cross-sections, or open-shaped, such as a stripe. The discharge cells 180 can also have delta arrangements or waffle arrangements.

The pairs of sustain electrodes 112 are disposed on the front substrate 111 opposing the rear substrate 121. Each of the pairs of sustain electrodes 112 is a pair of sustain electrodes 131 and 132 disposed on the rear of the front substrate 111 to generate a sustain discharge. The pairs of sustain electrodes 112 are disposed parallel to each other and spaced apart by a predetermined gap on the front substrate 111. Ones of the pairs of sustain electrodes 112 are X electrodes 131 and serve as common electrodes, and the others are Y electrodes 132 and serve as scan electrodes. In the current embodiment of the present invention, the pairs of sustain electrodes 112 are directly disposed on the front substrate 111. However, the present invention is not limited thereto. For example, the pairs of sustain electrodes 112 can be spaced apart from each other by a predetermined gap in a direction from the front substrate 111 to the rear substrate 121.

The X electrodes 131 and the Y electrodes 132 respectively include transparent electrodes 131a and 132a and bus electrodes 131b and 132b. The transparent electrodes 131a and 132a are formed of a transparent material which is a conductor for generating a discharge and does not prevent light emitted from the phosphor layers 126 from passing through the front substrate 111. The transparent material can be Indium Tin Oxide (ITO), etc. However, the transparent electrodes 131a and 132a formed of ITO have a high resistance, a high power consumption and a slow response speed due to a large voltage drop in a length direction. To address these problems, the bus electrodes 131b and 132b formed of a metal material and having a narrow width are disposed on the transparent electrodes 131a and 132a. The bus electrodes 131b and 132b can have a single-layer structure using a metal, such as Ag, Al, or Cu, and can have a multi-layer structure, such as Cr/Al/Cr, etc. The transparent electrodes 131a and 132a and bus electrodes 131b and 132b can be formed using a photo-etching method, a photolithography method, etc.

With regard to the shape and arrangement of the X electrodes 131 and the Y electrodes 132 with reference to FIGS. 2 through 4, the bus electrodes 131b and 132b are spaced apart from each other by a predetermined gap in the unit discharge cells 180, and extend to cross the discharge cells 180 disposed in a second direction. The bus electrodes 131b and 132b extend in the same direction as the X electrodes 131 and the Y electrodes 132. As described 18 above, the transparent electrodes 131a and 132a are electrically connected to each of the bus electrodes 131b and 132b. More particularly, the tetragonal transparent electrodes 131a and 132a are discontinuously arranged in each of the discharge cells 180.

Referring to FIG. 4, a virtual symmetry line P1-P1 is perpendicular to the bus electrodes 131b and 132b through the center C of each of the discharge cells 180. The transparent electrodes 131a of the X electrodes 131 and the transparent electrodes 132a of the Y electrodes 132 are symmetrical to each other on both sides of the symmetry line P1-P1. One side of each of the transparent electrodes 131a of the X electrodes 131 is connected to the bus electrodes 131b of the X electrodes 131, and another side extends toward the bus electrodes 132b of the Y electrodes 132. One side of each of the transparent electrodes 132a of the Y electrodes 132 is connected to the bus electrodes 132b of the Y electrodes 132, and another side extends toward the bus electrodes 131b of the X electrodes 131. The transparent electrodes 131a and 132a that oppose each other generate a plasma discharge, and areas therebetween are defined as discharge gaps 146. The discharge gaps 146 of PDPs, such as that of FIG. 1, are parallel to a first direction in which the bus electrodes 131b and 132b extend. However, the discharge gaps 146 of the current embodiment of the present invention substantially extend in a direction perpendicular to the bus electrodes 131b and 132b. In more detail, the discharge gaps 146 extend in the second direction of a virtual extension line C1-C1, and the virtual extension line C1-C1 crosses the first direction in which the bus electrodes 131b and 132b extend. The virtual extension line C1-C1 of the discharge gaps 146 is substantially parallel to opposing surfaces 131c and 132c of the transparent electrodes 131a and 132a, and is identical to the symmetry line P1-P1.

The opposing faces 131c and 132c of the transparent electrodes 131a and 132a are parallel to each other. Therefore, discharge paths between the opposing surfaces 131c and 132c have the same length, thereby uniformly generating the discharge between the transparent electrodes 131a and 132a.

The front dielectric layer 115 is formed on the front substrate 111 to bury the pairs of sustain electrodes 112. The front dielectric layer 115 prevents direct conduction between the adjacent X electrodes 131 and Y electrodes 132, and simultaneously prevents the X electrodes 131 and Y electrodes 132 from being damaged due to direct collisions of charged particles or electrons with the X electrodes 131 and Y electrodes 132. Also, the front dielectric layer 115 induces charges and can be formed of PbO, B₂O₃, SiO₂, etc.

Grooves 145 are formed in the front dielectric layer 115 and correspond to the discharge gaps 146. The grooves 145 have a predetermined depth, which is determined based on the possibility of damage to the front dielectric layer 115, the arrangement of wall charges, the discharge voltage, etc. For example, the grooves 145 can be formed to expose the front substrate 111.

Referring to FIGS. 2 and 4, each of the grooves 145 is formed in each of the discharge cells 180. Since the thickness of the front dielectric layer 115 is reduced by the grooves 145, the forward transmission rate of visible light is improved. In particular, since the length L2 of the discharge cells 180 in the second direction is longer than the length L1 of the discharge cells 180 in the first direction, the grooves 145 formed in the second direction have relatively larger cross-sections than those formed in the first direction, thereby improving the transmission rate of visible light.

Referring to FIG. 4, in the current embodiment of the present invention, the grooves 145 have tetragonal cross-sections. However, the present invention is not limited thereto and the grooves 145 can have a variety of shapes. Also, the grooves 145 are disposed in the same direction as the virtual extension line C1-C1 of the discharge gaps 146 and, in particular, are arranged along the virtual extension line C1-C1.

Referring to FIG. 3, the PDP 100 can further include the protective layer 116 covering the front dielectric layer 115. The protective layer 116 prevents the front dielectric layer 115 from being damaged due to collisions of charged particles and electrons with the front dielectric layer 115 during the discharge. In particular, an electric field is focused on projections 119a and 119b, and the protective layer 116 can cover the projections 119a and 119b in order to prevent the front dielectric layer 115 from being damaged. Also, the protective layer 116 emits a large amount of secondary electrons during the discharge to actively generate the plasma discharge. The protective layer 116 is formed of a material having a high coefficient of secondary electrons emission and a high transmission rate of visible light. The protective layer 116 is formed using sputtering, electronic beam deposition, etc. after the front dielectric layer 115 is formed.

The address electrodes 122 are disposed on the rear substrate 121 opposing the front substrate 111. The address electrodes 122 extend over the discharge cells 180 to cross the X electrodes 13 land the Y electrodes 132.

The address electrodes 122 generate an address discharge to facilitate a sustain discharge between the X electrodes 131 and the Y electrodes 132, and, more particularly, reduce a voltage needed for generating the sustain discharge. The address discharge is generated between the Y electrodes 132 and the address electrodes 132. If the address discharge is terminated, wall charges are accumulated in the Y electrodes 132 and the X electrodes 131, so that the sustain discharge between the X electrodes 131 and the Y electrodes 132 can be facilitated.

A rear dielectric layer 125 is formed on the rear substrate 121 to bury the address electrodes 122. The rear dielectric layer 125 is formed of a dielectric substance capable of preventing the address electrodes 122 from being damaged due to collisions of charged particles or electrons with the address electrodes 122 and inducing charges. The dielectric substance can be PbO, B₂O₃, SiO₂, etc.

The red, green, and blue light emitting phosphor layers 126 are disposed on both sides of the barrier ribs 130 formed on the rear dielectric layer 125 and on the entire surface of the rear dielectric layer 125 where the barrier ribs 130 are not formed. The phosphor layers 126 have a component generating visible light in response to ultraviolet rays. That is, a phosphor layer formed in a red light-emitting discharge cell has a phosphor such as Y(V,P)O₄:Eu, a phosphor layer formed in a green light-emitting discharge cell has a phosphor such as Zn₂SiO₄:Mn, YBO₃:Tb, and a phosphor layer formed in a blue light-emitting discharge cell has a phosphor such as BAM:Eu.

A discharge gas such as Ne, Xe, or a mixture thereof is sealed in the discharge cells is 180. In this state, the front substrate 111 and the rear substrate 121 are sealed by a sealing member, such as a frit glass, formed on edges of the front substrate 111 and the rear substrate 121.

The operation of the PDP 100 having the above structure is as follows.

A plasma discharge generated in the PDP 100 is divided into the address discharge and the sustain discharge. The address discharge is generated by supplying an address discharge voltage between the address electrodes 122 and the Y electrodes 132, so that the discharge cells 180 where the sustain discharge is generated are selected.

A sustain voltage is supplied between the X electrodes 131 and the Y electrodes 132 of the selected discharge cells 180. An electric field is focused on the grooves 145 formed in the front dielectric layer 115. Because a discharge path between the X electrodes 131 and the Y electrodes 132 is reduced, a strong magnetic field is generated to focus the electric field on the discharge path, and charges, charged particles, excited species, etc. have a high density. Therefore, the discharge is actively generated, thereby reducing a discharge voltage.

In particular, since the length L2 of the discharge cells 180 in the second direction is longer than the length L1 of the discharge cells 180 in the first direction, the length of the transparent electrodes 131a and 132a can be increased. Therefore, since the areas of the transparent electrodes 131a and 132a that mainly generate the discharge can increase, the transparent electrodes 131a and 132a generate more discharge than others, thereby improving the brightness and luminous efficiency of the PDP 100.

An energy level of the discharge gas excited by the sustain discharge is reduced, thereby discharging ultraviolet rays. The ultraviolet rays excite the phosphor layers 126 coated in the discharge cells 180, such that an energy level of the excited phosphor layers 126 is reduced to discharge visible light which transmits the front dielectric layer 115 and the front substrate 111 and forms an image recognized by a user.

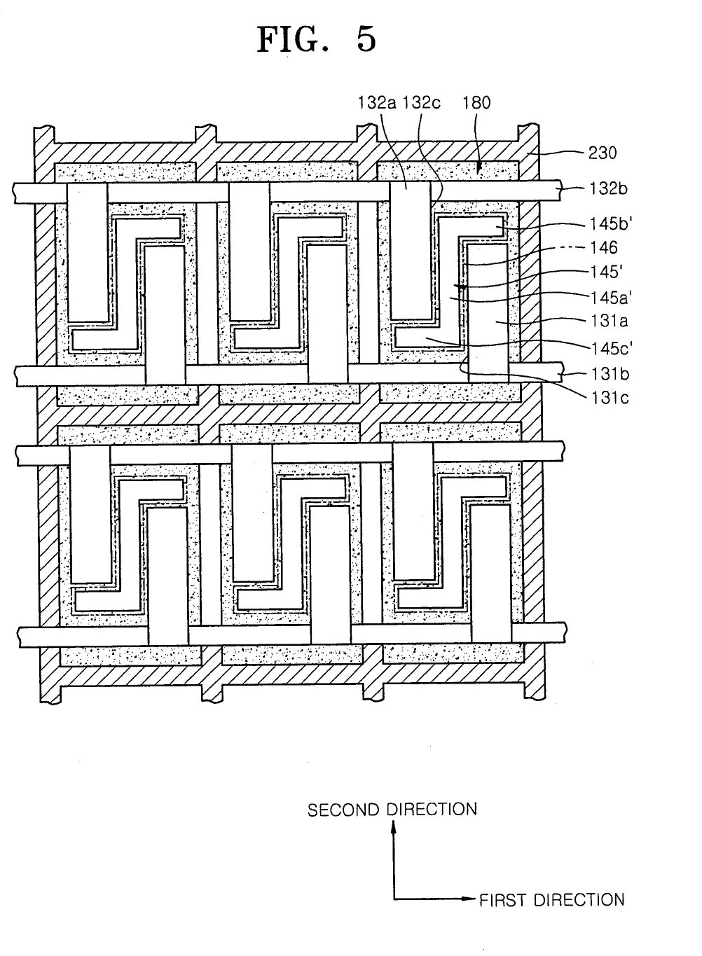

FIG. 5 is a partially exploded perspective view of a PDP according to another embodiment of the present invention. Like reference numerals in the drawings denote like elements.

The difference between the PDP of the previous embodiment and the PDP of the current embodiment is the shape of grooves 145′. Referring to FIG. 5, the grooves 145′ include first portions 145a′ formed between the transparent electrodes 131a and 132a corresponding to the grooves 145′, second portions 145b′ extending from the first portions 145a′ and formed between the transparent electrodes 131a of the X electrodes 131 and the bus electrodes 132b of the Y electrodes 132, and third portions 145c′ extending from the first portions 145a′ and formed between the transparent electrodes 132a of the Y electrodes 132 and the bus electrodes 131b of the X electrodes 131. Therefore, since the grooves 145′ further include the second portions 145b′ and the third portions 145c′ in addition to the first portions 145a′, the forward transmission rate of visible light is increased. Also, since an electric field is focused on the second portions 145b′ besides the first portions 145a′, a discharge is actively generated between the transparent electrodes 131a of the X electrodes 131 and the bus electrodes 132b of the Y electrodes 132. Furthermore, since the electric field is focused on the third portions 145c′, the discharge is actively generated between the transparent electrodes 132a of the Y electrodes 132 and the bus electrodes 131b of the X electrodes 131.

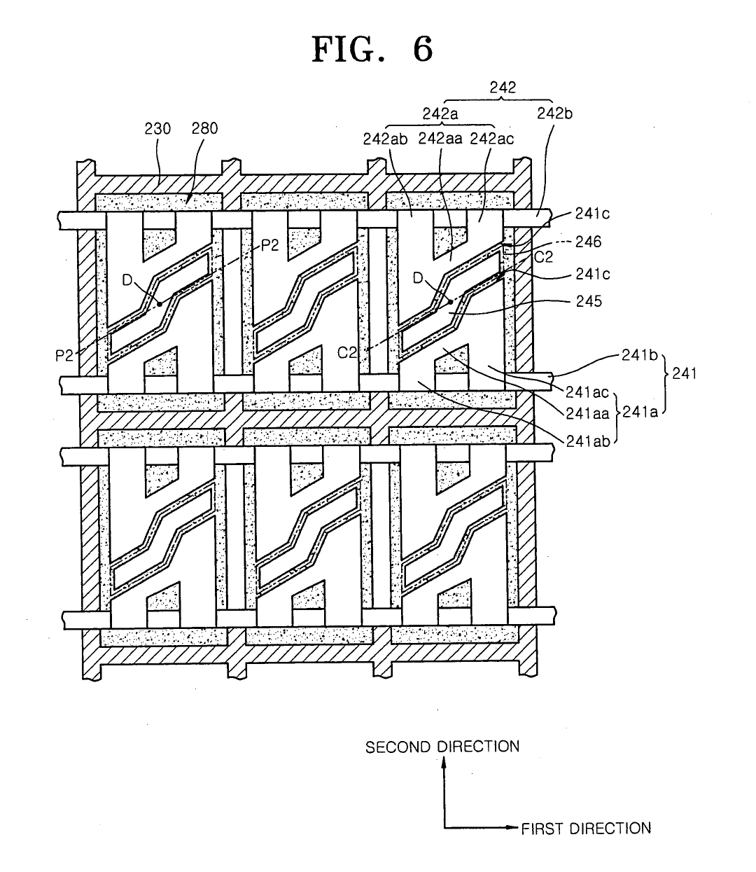

FIG. 6 is a layout diagram of sustain electrodes 231, 232, and 222, barrier ribs 230, and grooves 280 according to another embodiment of the present invention.

Referring to FIG. 6, the barrier ribs 230 partition the discharge cells 280 having rectangular cross-sections arranged in a matrix. The X electrodes 241 and the Y electrodes 242 that make pairs are spaced apart from each other by a predetermined gap and extend to cross the discharge cells 280 disposed in a first direction. The X electrodes 241 include the bus electrodes 241b extending in the first direction in the shape of a stripe and the transparent electrodes 241a electrically connected to the bus electrodes 241b. The Y electrodes 242 include the bus electrodes 242b extending in the first direction in the shape of a stripe and the transparent electrodes 241a electrically connected to the bus electrodes 242b. Each of the transparent electrodes 241a and 242a corresponds to each of the discharge cells 280. Also, the bus electrodes 241b and 242b extend in the same direction as the X electrodes 241 and the Y electrodes 242 extend.

Referring to FIG. 6, a virtual symmetry line P2-P2 is perpendicular to the bus electrodes 241b and 242b through the center D of each of the discharge cells 280. The transparent electrodes 241a of the X electrodes 241 and the transparent electrodes 242a of the Y electrodes 242 are symmetrical to each other at both sides of the symmetry line P2-P2. The transparent electrodes 241a of the X electrodes 241 include main body portions 241aa opposing to each other and first and second connection portions 241ab and 241ac connecting the main body portions 241aa and the bus electrodes 241b. The transparent electrodes 242a of the Y electrodes 242 include main body portions 242aa opposing to each other and first and second connection portions 242ab and 242ac connecting the main body portions 242aa and the bus electrodes 242b.

The transparent electrodes 241a and 242a opposing to each other generate a plasma discharge and areas between the transparent electrodes 241a and 242a are defined as discharge gaps 246. The discharge gaps 146 substantially extend in an oblique direction of the bus electrodes 241b and 242b. In more detail, the discharge gaps 245 substantially extend in a virtual extension line C2-C2, and the virtual extension line C2-C2 is oblique to a second direction in which the bus electrodes 231b and 232b extend. The virtual extension line C2-C2 of the discharge gaps 245 is substantially parallel to opposing surfaces 241c and 242c of the transparent electrodes 241a and 242a.

Since the PDP having the above structure includes the obliquely extending discharge gaps 246, the length of the discharge gaps 246 is increased. Therefore, since the area of the transparent electrodes 241a and 242a opposing each other is increased, the discharge is more actively generated, thereby improving brightness and luminous efficiency. Also, the grooves 245 are formed in the discharge gaps 246, thereby increasing the forward transmission rate of visible light. An electric field is focused on the grooves 245, thereby reducing a discharge voltage.

The operation of the PDP of the current embodiment is similar to that of the PDP of the previous embodiment and thus a detailed description thereof has been omitted.

According to the PDP of the present invention, since grooves are formed in a front dielectric layer, an electric field is focused on the grooves, a discharge voltage is reduced, and the luminous efficiency is increased. Also, since an average thickness of the front dielectric layer is reduced, the forward transmission rate of visible light is improved.

Since an area of the sustain electrodes that generate a discharge is increased, the X discharge is actively generated, thereby improving brightness and luminous efficiency.

While the present invention has been particularly shown and described with reference to exemplary embodiments thereof, it is understood that various modifications in form and detail can be made therein without departing from the spirit and scope of the present invention as defined by the following claims.

What is claimed is:

1. A Plasma Display Panel (PDP), comprising:
a substrate;
at least one pair of sustain electrodes arranged on the substrate; and
a dielectric layer covering the sustain electrodes;
wherein a virtual extension line of discharge gaps between the at least one pair of sustain electrodes crosses a direction in which the at least one pair of sustain electrodes extend, and wherein grooves corresponding to the discharge gaps are arranged on the dielectric layer.

2. The PDP of claim 1, wherein at least some of the grooves are parallel to the discharge gaps.

3. The PDP of claim 1, wherein the at least one pair of sustain electrodes comprise bus electrodes extending parallel to each other, and transparent electrodes respectively electrically connected to the bus electrodes;
wherein the virtual extension line of the discharge gaps is parallel to opposing surfaces of pairs of transparent electrodes.

4. The PDP of claim 3, wherein at least some of the grooves are parallel to the opposing surfaces of the pairs of transparent electrodes.

5. The PDP of claim 1, wherein the virtual extension line of the discharge gaps is oblique to the direction in which the at least one pair of sustain electrodes extend.

6. The PDP of claim 1, wherein the virtual extension line of the discharge gaps crosses the direction in which the at least one pair of sustain electrodes extend.

7. A Plasma Display Panel (PDP), comprising:
a front substrate and a rear substrate opposing each other;
barrier ribs arranged between the front substrate and the rear substrate and partitioning a plurality of discharge cells;
a plurality of pairs of sustain electrodes spaced apart from each other on the front substrate opposing to the rear substrate;
address electrodes extending to cross the plurality of pairs of sustain electrodes;
a front dielectric layer covering the plurality of pairs of sustain electrodes;
a rear dielectric layer disposed to cover the address electrodes;
phosphor layers arranged within the plurality of discharge cells; and
a discharge gas contained within the plurality of discharge cells;
wherein a virtual extension line of discharge gaps between the pairs of sustain electrodes crosses a direction in which the pairs of sustain electrodes extend, and wherein grooves corresponding to the discharge gaps are arranged on the front dielectric layer.

8. The PDP of claim 7, wherein at least some of the grooves are parallel to the discharge gaps.

9. The PDP of claim 7, wherein the pairs of sustain electrodes comprise bus electrodes extending parallel to each other, and transparent electrodes respectively electrically connected to the bus electrodes;
wherein the virtual extension line of the discharge gaps is parallel to opposing surfaces of pairs of transparent electrodes.

10. The PDP of claim 9, wherein at least some of the grooves are parallel to the opposing surfaces of the pairs of transparent electrodes.

11. The PDP of claim 7, wherein the virtual extension line of the discharge gaps is oblique to the direction in which the pairs of sustain electrodes extend.

12. The PDP of claim 7, wherein the virtual extension line of the discharge gaps crosses the direction in which the pairs of sustain electrodes extend.

13. The PDP of claim 7, wherein the front substrate is exposed through the grooves.

14. The PDP of claim 7, wherein the grooves are discontinuously formed in each of the plurality of discharge cells.
